(19) United States
(12) Patent Application Publication
(10) Pub. No.: US 2020/0338799 A1
(43) Pub. Date: Oct. 29, 2020

(54) COEXTRUDED RIBBON FOR ROLLER SURFACES BACKGROUND

(71) Applicant: 3M INNOVATIVE PROPERTIES COMPANY, St. Paul, MN (US)

(72) Inventors: Joshua M. Retterath, Cannon Falls, MN (US); Emma M. Abbott, Menlo Park, CA (US); Bruce E. Tait, Woodbury, MN (US); Anthony L. Hill, River Falls, WI (US); Ronald W. Ausen, St. Paul, MN (US); Ramasubramani Kuduva Raman Thanumoorthy, Woodbury, MN (US); Jeffrey M. Imsande, Menomonie, WI (US); David J. Kinning, Woodbury, MN (US); Maria A. Appeaning, St. Paul, MN (US); Georgiy Teverovskiy, St. Louis Park, MN (US)

(21) Appl. No.: 16/757,888

(22) PCT Filed: Oct. 31, 2018
(86) PCT No.: PCT/IB2018/058542

§ 371 Date: Apr. 21, 2020

Related U.S. Application Data
(60) Provisional application No. 62/580,866, filed on Nov. 2, 2017.

(51) Int. Cl. B29C 48/07; B29C 48/21; B32B 3/30; B32B 7/12

(52) U.S. Cl. CPC B29C 48/07; B32B 7/12; B32B 3/30; B29C 48/21

(57) ABSTRACT

A coextruded ribbon. The coextruded ribbon includes a first layer and an opposed second layer. The first layer includes a first side optionally having an adhesive thereon. The first layer further includes an opposed second side having a plurality of protrusions extending therefrom. The second layer includes a repellant material contacting the plurality of protrusions.

### CROSS REFERENCE TO RELATED APPLICATION

This application claims the benefit of U.S. Provisional Patent Application No. 62/580,866, filed Nov. 2, 2017, the disclosure of which is incorporated by reference herein in its entirety.

Some products are manufactured as a continuous web with an adhesive coated on at least one side. During the course of manufacture, the adhesive can make contact with at least one roller. While this can facilitate efficient transport of the web, adhesive may undesirably adhere to the roller. When the web is removed from the roller, some of the adhesive may be left remain on the surface of the roller. This can result in damage to the adhesive and required frequent production stoppages in order to clean the roller.

### SUMMARY OF THE DISCLOSURE

Various embodiments disclosed relate to a coextruded ribbon. In one aspect, the coextruded ribbon comprising first and second layers:

the first layer comprising a polymeric material and further comprising:
a first side optionally having an adhesive thereon; and
an opposed second side having a plurality of protrusions extending therefrom,

and the second layer comprising a repellant material contacting the plurality of protrusions.

In a second aspect, an assembly for forming adhesive articles comprises a coextruded ribbon comprising first and second layers:

the first layer comprising a polymeric material and further comprising:
a first side optionally having an adhesive thereon; and
an opposed second side having a plurality of protrusions extending therefrom,
and the second layer comprising a repellant material contacting the plurality of protrusions.

The assembly further includes a roller and the first side is in contact with the roller. In yet another aspect a method of making a coextruded ribbon comprises:

coextruding a mixture of a polymeric material and a repellant material through a die, wherein the polymeric material forms a first layer and the repellant material forms a second layer, and wherein the die forms a plurality of protrusions on the first layer to which the second layer is attached.

Various exemplary embodiments of the present disclosure offer certain advantages, at some of which are unexpected. For example, in some embodiments, according to the present disclosure, including the coextruded ribbon in an assembly for manufacturing or transporting an adhesive article may reduce the tendency of the adhesive to remain adhered to a roller. This may help to reduce damage to the adhesive and reduce the amount of adhesive that remains on a roller after the article breaks contact with the roller. Reducing the tendency of the adhesive to remain on the roller permits longer run times between shutdowns for cleanup, permits faster run rates, and reduces or eliminates the need for frequent provision, installation, removal, and disposal of release liners. Use of such transport rolls described herein may permit the change of various production parameters (e.g., switching adhesive compositions) with reduced or eliminated retooling, leading to greater manufacturing efficiency and cost reduction.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a perspective view of an exemplary coextruded ribbon described herein.

FIG. 2A is a sectional view of the coextruded ribbon taken along line 2A of FIG. 1.

FIG. 2B is a sectional view of another exemplary coextruded ribbon described herein.

FIG. 2C is a sectional view of another exemplary coextruded ribbon described herein.

FIG. 2D is a sectional view of another exemplary coextruded ribbon described herein.

FIG. 2E is a sectional view of another exemplary coextruded ribbon described herein including a discontinuous second layer.

FIG. 3 is a sectional view of a portion of an assembly including an exemplary coextruded ribbon described herein.

FIG. 4 is a perspective view of a die that can be used to extrude an exemplary coextruded ribbon described herein.

FIG. 5A is a schematic view showing a plurality of orifices in an exemplary die described herein.

FIG. 5B is a perspective view showing orifices and shims stacked together in an exemplary die described herein.

FIG. 5C is an exploded view of orifices in an exemplary die described herein.

FIG. 6A shows a first pattern of orifices in an exemplary die described herein.

FIG. 6B is a zoomed view of a portion of a tip of exemplary die of FIG. 6A.

FIG. 7A shows a second pattern of orifices in an exemplary die described herein.

FIG. 7B is a zoomed view of a portion of a tip of exemplary die of FIG. 7A.

FIG. 8A shows a third pattern of orifices in an exemplary die described herein.

FIG. 8B is a zoomed view of a portion of a tip of exemplary die of FIG. 8A.

FIG. 9 is a photograph showing an exemplary coextruded ribbon described herein.

FIG. 10 is a schematic diagram showing an exemplary apparatus for measuring peel force.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or4 “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include at least one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading can occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least 50%, 60%, 70%, 80%, 90%, 95%, 96%, 97%, 98%, 99%, 99.5%, 99.9%, 99.99%, or at least 99.999%, or even 100%.

The term “organic group” as used herein refers to any carbon-containing functional group. Exemplary functional groups include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Exemplary organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which at least one hydrogen atoms contained therein are replaced by at least one non-hydrogen atoms. The term “functional group” or “substituent” as used herein refers to a group that can be or is substituted onto a molecule or onto an organic group. Exemplary substituents or functional groups include a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Exemplary substituents that can be bonded to a substituted carbon (or other) atom include F, Cl, Br, I, OR, OC(O)N(R)₂, CN, NO, NO₂, ONO₂,azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 (in some embodiments, 1 to 20, 1 to 12, or even 1 to 8) carbon atoms. Exemplary straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Exemplary substituted alkyl groups can be substituted at least one time with any of the groups listed herein (e.g., amino, hydroxy, cyano, carboxy, nitro, thio, alkoxy, and halogen groups).

The term “alkenyl” as used herein refers to straight and branched chain and cyclic alkyl groups as defined herein, except that at least one double bond exists between two carbon atoms. Thus, alkenyl groups have from 2 to 40 (in some embodiments, 2 to 20, 2 to 12 or even 2 to 8) carbon atoms. Exemplary alkenyl groups include —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40, (in some embodiments, 2 to 20, 2 to 12, or even 2 to 8) carbon atoms. Exemplary alkynyl groups include C≡CH, —C≡C(CH₃), —C≡C(CH₂CH₃), —CH₂C≡CH, —CH₂C≡C(CH₃), and —CH₂C≡C(CH₂CH₃).

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heteroaryl, or heteroarylalkyl group. An acyl group can include 0 to 12 (in some embodiments, 0 to 20, or even 0 to 40) additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other exemplary acryloyl group include acetyl, benzoyl, phenylacetyl, pyridylacetyl, cinnamoyl, and acryloyl groups. When the group containing the carbon atom that is bonded to the carbonyl carbon atom contains a halogen, the group is termed a “haloacyl” group. An exemplary haloacyl group is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members. In some embodiments, whereas in other embodiments the number of ring carbon atoms range from 3 to 4, 3 to 5, 3 to 6, or even 3 to 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl. Cycloalkyl groups also include rings that are substituted with straight or branched chain alkyl groups as defined herein. Exemplary representative substituted cycloalkyl groups can be mono-substituted or substituted more than once, such as, 2,2-, 2,3-, 2,4- 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain 6 to 14 carbons in the ring portions of the groups. Aryl groups can be unsubstituted or substituted, as defined herein. Exemplary representative substituted aryl groups can be mono-substituted or substituted more than once, such as a phenyl group substituted at any of at least one of 2-, 3-, 4-, 5-, or 6-positions of the phenyl ring, or a naphthyl group substituted at any of at least one of 2- to 8-positions thereof.

The term “heterocyclyl” as used herein refers to aromatic and non-aromatic ring compounds containing at least three ring members, of which at least one is a heteroatom such as N, O, and S.

The term “alkoxy” as used herein refers to an oxygen atom connected to an alkyl group, including a cycloalkyl group, as are defined herein. Exemplary linear alkoxy groups include methoxy, ethoxy, propoxy, butoxy, pentyloxy, and hexyloxy. Exemplary branched alkoxy include isopropoxy, sec-butoxy, tert-butoxy, isopentyloxy, and isohexyloxy. Exemplary cyclic alkoxy include cyclopropyloxy, cyclobutyloxy, cyclopentyloxy, and cyclohexyloxy. An alkoxy group can include 1 to 12 (in some embodiments, 1 to 20, or even 1 to 40) carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, for example, the formula N(group)₃, wherein each group can independently be H or non-H, such as alkyl and aryl. Amines include R—NH₂, alkylamines, arylamines, alkylarylamines; R₂NH wherein each R is independently selected, such as dialkylamines, diarylamines, aralkylamines, and heterocyclylamines; and R₃N wherein each R is independently selected, such as trialkylamines, dialkylarylamines, alkyldiarylamines, and triarylamines. The term “amine” also includes ammonium ions as used herein.

The term “hydrocarbon” or “hydrocarbyl” as used herein refers to a molecule or functional group that includes carbon and hydrogen atoms. The term can also refer to a molecule or functional group that normally includes both carbon and hydrogen atoms, but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl (i.e., in some embodiments, there is no hydrocarbyl group).

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

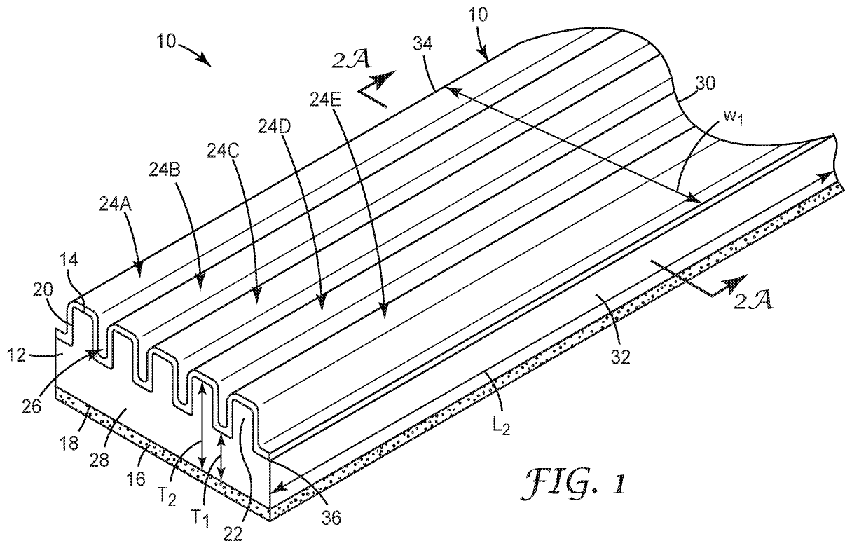

Referring to FIG. 1, exemplary coextruded ribbon 10 is shown. Coextruded ribbon 10 has a width WI and length Li. Coextruded ribbon 10 includes first layer 12, second layer 14, and adhesive layer 16. First layer 12 includes first side 18 and opposed second side 20. As shown in FIG. 1, first side 18 is substantially planar. In other embodiments, however, first side 18 can be nonplanar. For example, first side 18 can have an undulating, curved, or otherwise irregular profile.

Second side 20 defines a plurality of elongated protrusions or rails 22 that extend from a point of minimal thickness T₁ of first layer 18 to a point of maximum thickness T₂ of first layer 18. A height of each protrusion 22 is characterized as the difference between T₂ and T₁. Protrusions 22 are arranged in adjacent rows 24A to 24E; although five rows are shown in FIG. 1, additional embodiments may include at least one or even at least six rows of protrusions 22. Cavities 26 are located between adjacent protrusions 22. A depth of a respective cavity 26 is characterized as the difference between T₂ and T₁. As shown in FIG. 1, Rows 24A to 24E extend between first end 28 and second end 30 for coextruded ribbon 10 along L₁. In other embodiments, however, rows 24A to 24E may extend between side surfaces 32 and 34 of coextruded ribbon 10 along W₁.

As shown in FIG. 1, the height of each protrusion 22 is substantially the same. In other embodiments, however, each protrusion 22 may, independently, have a different height. Additionally, the height of each protrusion 22 is shown as constant across L₁. In other embodiments, however, individual protrusions 22 may have a variable height across L₁. While not so limited, examples of suitable heights for each protrusion 22, may be independently in a range of 0.1 mm to 5.0 mm (in some embodiments, 0.5 mm to 4.5 mm, 1.0 mm to 4.0 mm, 1.5 mm to 3.5 mm, or even 2.0 mm to 3.0 mm).

A distance between adjacent protrusions 22 may be characterized as a pitch. As shown in FIG. 1, the pitch between adjacent protrusions 22 is substantially the same. In other embodiments, however, the pitch between adjacent protrusions 22 may be different. Additionally, the pitch between adjacent protrusions 22 is shown as constant across L₁. In other embodiments, however, individual protrusions 22 may have a variable pitch across L₁. While not so limited, examples of suitable pitch values may be in a range of from 0.2 mm to 5 mm (in some embodiments, 0.5 mm to 4.5 mm, 1.0 mm to 4.0 mm, 1.5 mm to 3.5 mm, or even 2.0 mm to 3 mm). A height to pitch ratio between adjacent protrusions 22, or an average height to pitch ratio of coextruded ribbon 10 may be in a range of from 1:1 to 1:10 (in some embodiments, 1:2 to 1:9, 1:3 to 1:8, 1:4 to 1:7, or even 1:5 to 1:6).

First layer 12 comprises a polymeric material. Factors that influence the choice of polymeric material may include the modulus, resiliency, elasticity, or transparency thereof. For example, the polymeric material may include at least one of a polyester (e.g., polyethylene terephthalate), a polyurethane, a polyethylene, a polypropylene, a mixture thereof, or a copolymer thereof. In embodiments where the polymeric material comprises polyethylene, the polyethylene may have a density in a range from 0.80 g/cm³ to 0.86 g/cm³ (in some embodiments, 0.81 g/cm³ to 0.85 g/cm³, or even from 0.82 g/cm³ to 0.84 g/cm³). In additional embodiments, the polyethylene may have a density in a range from 0.90 g/cm³ to 0.92 g/cm³ (in some embodiments, 0.90 g/cm³ to 0.91 g/cm³). In further embodiments, the polyethylene may have a density in a range from 0.92 g/cm³ to 0.96 g/cm³ (in some embodiments, 0.93 g/cm³ to 0.95 g/cm³).

Second layer 14 of coextruded ribbon 10 is joined to first layer 12 along protrusions 22. As shown, second layer 14 contacts each protrusion. In other embodiments, however, second layer 14 may be configured (e.g., through post-processing removal of material) to contact only a portion of the total number of protrusions 22 or only a portion of a respective protrusion 22. The portion may be in a range of from 50% to 100% (in some embodiments, 55% to 100%, 60% to 100%, 65% to 100%, 70% to 100%, 75% to 100%, 80% to 100%, 85% to 100%, 90% to 100%, or even 95% to 100%) of the protrusions.

Second layer 14 includes a different material than that of first layer 12. The material of second layer 14 is a repellant material. A material is repellant if an adhesive (e.g., in the form of an adhesive film) in contact with the second layer, and when removed from second layer 14, imparts little to no damage to the adhesive. Exemplary repellant materials include silicones or polysiloxanes, which can be radiation curable silicones and other reactive silicones. Exemplary silicones include polydiorganosiloxane-polyurea copolymers and blends thereof. Further exemplary release coatings include silicone, solvent and solventless types, thermal cure and radiation cure types, condensation cure types and addition cure types, epoxide functional, acrylate functional, silanol functional types, silicone hydride functional types, and modifiers. An example of a suitable repellant material that can be incorporated into the extrudable material or coated as a release material is a fluorocarbon material or a mixture of a thermoplastic polymer and a fluoropolymer additive.

In some embodiments, the silicone material is a compound, oligomer or polymer having a polysiloxane backbone such as a polydimethylsiloxane backbone. The polysiloxane backbone may include pendent groups, such as hydrocarbon (e.g., (C₂-C₄₀)alkyl groups). In some examples, the silicone material is free of (i.e., contains less than 2 (in some embodiments, less than 1.5, 1, 0.5, 0.25, or even 0) percent by weight, based on the total weight of the silicone material) vinyl groups or other polymerizable groups that would result in the silicone material forming a crosslinked network.

In some embodiments, the siloxane (e.g., PDMS) material (e.g., oligomer or polymer) comprises at least 50 (in some embodiments, at least 55, 60, 65, 70, 75, 80, 85, 90, or even at least 95) wt. % polydimethylsiloxane backbone, based on the total weight siloxane. In some embodiments, the siloxane material further comprises pendent longer chain hydrocarbon (e.g., alkyl) groups in an amount of at least 5 (in some embodiments, at least 10, 15, 20, 25, 30, or even at least 35) wt. % of the siloxane material.

In some embodiments, the siloxane oligomer has a weight-average molecular weight of at least 1500 g/mole (in some embodiments, at least 2000 g/mole). In some embodiments, the siloxane oligomer has a molecular weight no greater than 10,000 (in some embodiments, no greater than 9000, 8000, or even no greater than 7000) g/mole. In some embodiments, the siloxane polymer has a molecular weight greater than 10,000 (in some embodiments, greater than 15,000 or even greater than 20,000) g/mole. In some embodiments, the molecular weight of the siloxane polymer is no greater than 100,000 (in some embodiments, no greater than 75,000 or 50,000) g/mole.

In some embodiments, the siloxane material comprises pendent longer chain hydrocarbon (e.g., alkyl) groups, wherein the longer chain hydrocarbon groups average at least 8 (in some embodiments, at least 10, 12, 14, 16, 18, or even at least 20) carbon atoms. In some embodiments, the siloxane material comprises pendent longer chain hydrocarbon groups, wherein the longer chain hydrocarbon groups average greater than 20 carbons atoms such as, at least 25 (in some embodiments, at least 30, 35, or even at least 40) carbon atoms. The pendent longer chain hydrocarbon groups may average no greater than 75 (in some embodiments, no greater than 70, 65, 60, or even greater than 50) carbon atoms.

In some embodiments, the siloxane material can be characterized as an alkyl dimethicone. In some embodiments, alkyl dimethicone comprises at least one linear, branched, or cyclic alkyl group averaging at least 8 (in some embodiments, at least 10, or even at least 12) carbon atoms such as lauryl dimethicone(I).

In some embodiments, the alkyl dimethicone comprises at least one linear, branched, or cyclic alkyl group averaging at least 14 (in some embodiments, at least 16 or even at least 18) carbon atoms such as cetyl dimethicone and stearyl dimethicone.

These materials are characterized by having a polysiloxane (e.g., linear polysiloxane) backbone having terminal (C₁-C₄)alkyl silane groups and a pendent alkyl group (e.g., a linear alkyl group). An exemplary alkyl dimethicones typically has a structure according to Formula I:

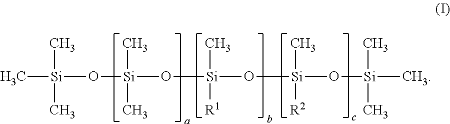

In Formula I, the sum of (a+b+c) is in a range from 100 to 1000 (in some embodiments, in a range from 200 to 500 or even 300 to 400). The ratio of a to the sum of (b+c) is in a range from 99.9:0.1 to 80:20 (in some examples in a range from 99:1 to 85:15, 99:1 to 90:10, 99:1 to 92:8, 98:2 to 93:7, or even 98:2 to 94:6). R¹ is at least one of linear, branched, or cyclic alkyl group having in a range from 20 to 50 (in some embodiments, in a range from 22 to 46, or even 24 to 40) carbon atoms. R² is a at least one of a linear, branched, or cyclic alkyl or alkaryl group having in a range from 2 to 16 carbons (in some embodiments, in a range from 4 to 16, 5 to 12, or even 6 to 10). The structure is at least one of a random, block, or alternating structure. In some embodiments, the ratio of a to (b+c) in conjunction with the number of carbons in the R¹ and R² groups result in an alkyl dimethicones having greater than about 50 wt. % dimethyl siloxane (a) units, or in embodiments greater than about 60 wt. % dimethyl siloxane units. In some embodiments, c is 0. In some embodiments, the sum of (a+b+c) is 300 to 400 and the ratio of “a” to the sum of (b+c) is 98:2 to 94:6. In some embodiments, the alkyl dimethicone is a blend of at least two species thereof, wherein the species differ in terms of the sum of (a+b+c), the ratio of “a” to the sum of (b+c), the value of c, or in at least two such parameters. In some embodiments, the alkyl dimethicone is a random structure. In some embodiments, R¹ is a linear alkyl group. In some embodiments, R² is a linear alkyl group.

The alkyl dimethicone materials of the Formula I above are characterized by having a (e.g., linear) polysiloxane backbone having terminal (C₁-C₄)alkyl silane groups and a plurality of pendent (e.g., linear) alkyl groups.

In some embodiments, the siloxane material can be characterized as a high molecular weight or ultra-high molecular weight (UHMW) polydimethylsiloxane (e.g., melt additive) material. In some embodiments, the siloxane material has a viscosity of at least 10,000 (in some embodiments, 25,000, 50,000, or even 100,000) centistokes. In other embodiments, the siloxane material has a viscosity at 25° C. greater than 100,000 (in some embodiments, 250,000, 500,000, 1,000,000, or even 5,000,000) centistokes; and typically, less than 10,000,000 centistokes. In yet other embodiments, the siloxane material can be characterized as an UHMW siloxane material having a viscosity greater than 10 million centistokes ranging up to 50 million centistokes. Viscosity can be measured at ambient temperature (i.e., about 25° C.) using a rheometer (obtained under the trade designation “GÖTTFERT RHEOGRAPH 2003 CAPILLARY RHEOMETER” from GÖTTFERT Werkstoff-Prüfmaschinen GmbH, Buchen, Germany). The rheometer is used according to the protocol of ASTM D3835 (2008), the disclosure of which is incorporated herein by reference.

In some embodiments, the siloxane material can be characterized as a siloxane copolymer or silicone-containing copolymer. The above-described alkyl dimethicone is one class of siloxane. Although a common suitable siloxane polymer backbone is polydimethylsiloxane (PDMS), the backbone of the siloxane polymer can include other substituents or polymerized units derived from other monomers, especially non-reactive polymerized units such a methyl phenyl siloxane, diphenyl siloxane, or 3,3,3-trifluoropropylmethyl siloxane, and combinations thereof.

The polydiorganosiloxane (“polysiloxane”) backbone comprises a repeating unit according to the structure of Formula II:

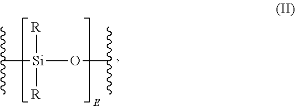

wherein each R is independently a (C₁-C₁₃) monovalent organic group. For example, R can be a (C₁-C₁₃)alkyl, (C₁-C₁₃)alkoxy, (C₂-C₁₃)alkenyl, (C₂-C₁₃)alkenyloxy, (C₃-C₆)cycloalkyl, (C₃-C₆)cycloalkoxy, (C₆-C₁₄)aryl, (C₆-C₁₀)aryloxy, (C₇-C₁₃)arylalkyl, (C₇-C₁₃)aralkoxy, (C₇-C₁₃)alkylaryl, and (C₂-C₁₃)alkylaryloxy. In an embodiment, where a transparent polysiloxane-polycarbonate is desired, R is free of (i.e., contains less than 2 percent; in some embodiments, less than 1.5, 1, 0.5, 0.25, or even 0 percent by weight) substitution by halogen. Combinations of the foregoing R groups can be used in the same copolymer.

The value of E in the above formula can vary. Generally, E has an average value of at least 2 (in some embodiments, at least 5, 10, 15, 20, 25, 30, 35, 40, 50, 100, 200, 300, 400, 500, 600, 700, 800, 900, or even at least 1,000).

In some embodiments, the siloxane copolymer comprises at least 50 (in some embodiments, at least 55, 60, 65, 70, 75, 80, 85, 90, or even at least 95) wt. % of polyorganosiloxane material, such as in the case of the previously-described alkyl dimethicone. In other embodiments, the siloxane copolymer comprises less than 50 wt. % polyorganosiloxane material. In some embodiments, the siloxane copolymer comprises at least 1 (in some embodiments, at least 1.5, 2, 2.5, 3, 3.5, 4, 4.5, or at least even 5) wt. % of polyorganosiloxane material. In other embodiments, the siloxane copolymer comprises at least 10 (in some embodiments, at least 15, 20, 25, or even at least 30) wt. % of polyorganosiloxane material.

Although in the case of the alkyl dimethicone copolymer depicted above, the alkyl group is bonded directly to a silicone atom of a siloxane backbone, when the siloxane copolymer is prepared from other synthetic routes the silicone copolymer may further comprise other groups within the copolymer. In such embodiments, the silicone copolymer can be characterized as a silicone urea copolymer, silicone-urethane copolymer, silicone-ester copolymer, silicone amide copolymer, or silicone imide copolymer.

As stated above, second layer 14 may also include a mixture of a thermoplastic polymer and a fluoropolymer additive. Exemplary thermoplastic polymers include a polyolefin, polyester, polyamide, polyurethane, polycarbonate, polystyrene, poly(alkyl acrylate), and polyacrylate.

In more specific examples, a polyolefin polymer or copolymer repeating unit is formed by the reaction of ethylene, propylene, butylene, hexene, or mixtures thereof. Thus, the polyolefin may be polypropylene, polyethylene, polybutylene, polyhexylene, or a blend or copolymer thereof. Other polyolefins include poly-α-olefins, and copolymers thereof, including low-density polyethylene (LDPE), high-density polyethylene (HDPE), linear low-density polyethylene (LLDPE), ultra-high-density polyethylene (UHDPE), and polyethylene-polypropylene copolymers, as well as polyolefin copolymers having non-olefin content (i.e., content derived from monomers that are not olefins).

The fluoropolymer additive may have a structure according to Formula III:

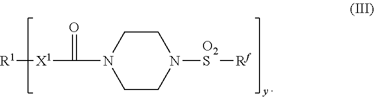

In Formula III R¹ is a linear or branched C₂-C₄₀ hydrocarbyl group; R^{f} is a perfluorinated group comprising a number average of 3 to 5 carbons; X¹ is selected from the group consisting of —NH— and a bond, and y is 1 to 3.

As shown herein with respect to Formula III, the fluorine-free hydrocarbyl moiety, designated R¹ in compounds of Formula III can be at least one of a linear or branched chain, saturated or unsaturated, cyclic or acyclic (or any combination thereof) alkyl or alkylene group having from 2 to 40 carbon atoms. Alternatively, R¹ can contain at least one of aryl or arylene groups.

Referring back to FIG. 1, coextruded ribbon 10 optionally includes adhesive layer 16 disposed on first side 18 of first layer 12. Adhesive layer 16 may be coextruded with first layer 12 and second layer 14, or disposed on first layer 12 in a post processing step. Adhesive layer 16 may be disposed in a range from 50% to 100% (in some embodiments, in a range from 55% to 95%, 60% to 90%, 65% to 85%, or even 70% to 80%) of a total surface area of first side 18. The adhesive of adhesive layer may be any suitable adhesive. For example, the adhesive may be a pressure-sensitive adhesive. Examples of pressure-sensitive adhesives include a natural rubber-based adhesive, a synthetic rubber-based adhesive, a styrene block copolymer-based adhesive, a polyvinyl ether-based adhesive, a poly(methyl acrylate)-based adhesive, a polyolefin-based adhesive, or a silicone-based adhesive. As used herein “based” means contains at least 50% weight, based on the total weight of the adhesive.

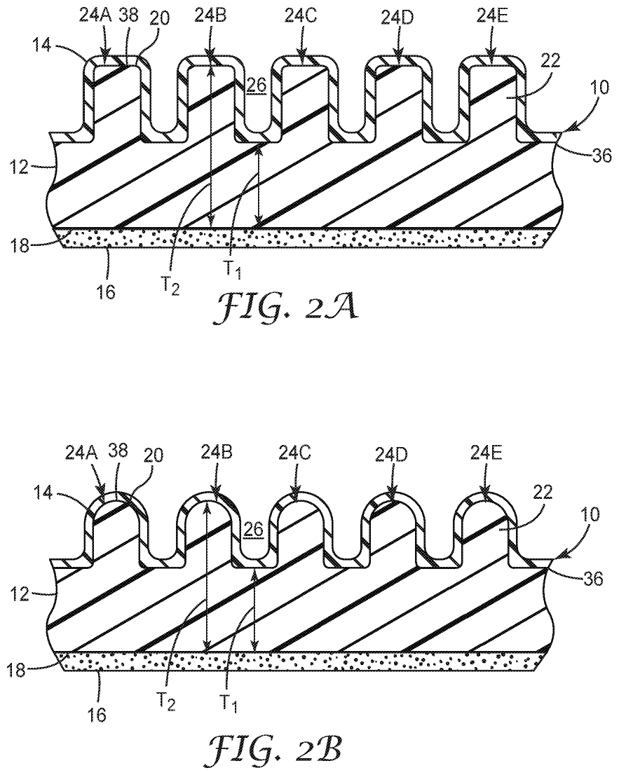

FIG. 2A is a sectional view of a coextruded ribbon 10 taken along line 2A of FIG. 1. As shown in FIG. 2A, coextruded second layer 14 and first layer 12 are joined along continuous interface 36. In some embodiments, second layer 14 may be discontinuous and may only contact tip 38 of protrusion 22. Tip 38 may be in a range from 0.5% to 5.0% (in some embodiments, in a range from 1% to 4.5%, 1.5% to 4.0%, or even 2.0% to 3.5%) of the height of the respective protrusion. Additionally, tips 38 of protrusions 22 may be in a range from 1.0% to 15.0% (in some embodiments, in a range from 1.5% to 14.5%, 2.0% to 14.0%, 2.5% to 13.5%, 3.0% to 13.0%, 3.5% to 12.5%, 4.0% to 12.0%, 4.5% to 11.5%, 5.0% to 11.0%, 5.5% to 10.5%, 6.0% to 10.0%, 6.5% to 9.5%, 7.0% to 9.0%, or even 7.5% to 8.5%) of the surface area of second side 20.

As shown in FIGS. 1 and 2A, each of protrusions 22 has a rectangular profile, defined by a rectangular cross-section. In other embodiments, protrusions 22 may have different profiles as defined by different cross-sectional shapes. For example, FIG. 2B shows protrusions 22 having a semi-circular or ovular cross-sectional shape in which protrusion 22 has straight walls and tip 38 is rounded. FIG. 2C shows protrusions 22 having a triangular cross-sectional shape. FIG. 2D, shows protrusions 22 having a trapezoidal shape. Additional cross-sectional shapes are possible in further embodiments. For example, any protrusion could have a pentagonal, hexagonal, heptagonal, or any higher-order polygonal cross-sectional shape.

In examples where interface 36 is continuous, the profile of second layer 14, will be congruent with the profile of protrusions. However, in some embodiments, it can be desirable to break the continuity of interface 36. FIG. 2E is a cross-sectional view of coextruded ribbon 10 in which interface 36, and thereby, second layer 14 is discontinuous. In this embodiment second layer is located on tips 38. As shown in FIG. 2E, respective portions of second layer 14 have a semi-circular profile defined by a semi-circular cross-sectional shape. However, second layer 14 may have any other profile as defined by a cross-sectional shape such as a triangle, a square, a rectangle, a diamond, a hexagon, or a trapezoid.

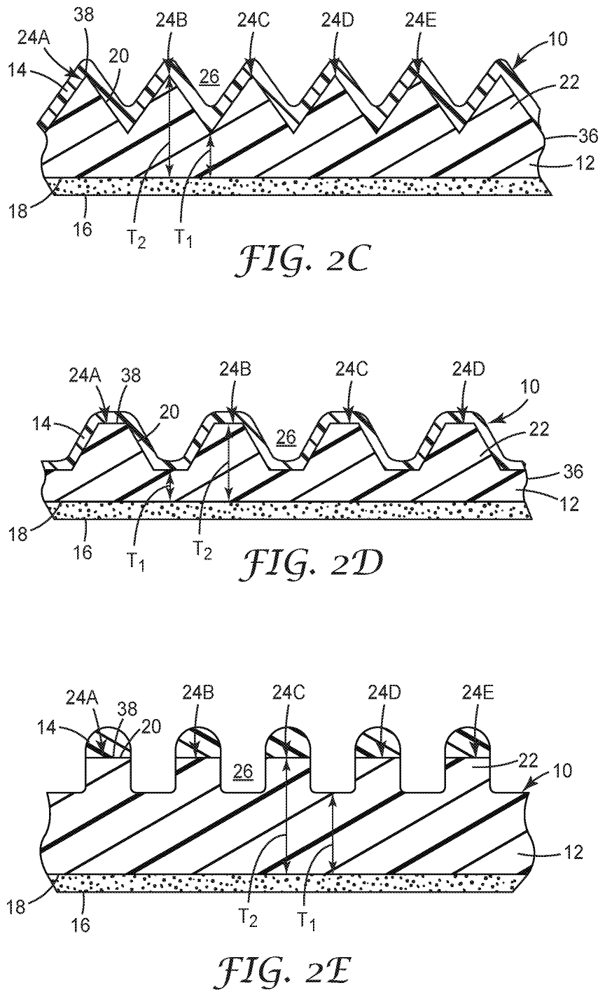

Coextruded ribbon 10 may be included in an assembly for forming or facilitating the transport of adhesive articles. FIG. 3 is a sectional view of a portion of assembly 50. In addition to coextruded ribbon 10, assembly 50 includes roller 52. Roller 52 may be an idle roller and may be one of any plural number of rollers in a system or assembly. Roller 52 contacts first side 18 via adhesive layer 16. Roller 52 may include any material that interacts to form good adhesion with adhesive layer 16. Coextruded ribbon 10 may be removably secured to roller 52 in that the adhesive may be chosen to be an adhesive that will allow coextruded ribbon 10 to be removed when replacement is necessary. Under certain circumstances, removal of coextruded ribbon 10 may be necessary if protrusions 22 are damaged or if at least a portion of second layer 14 is damaged.

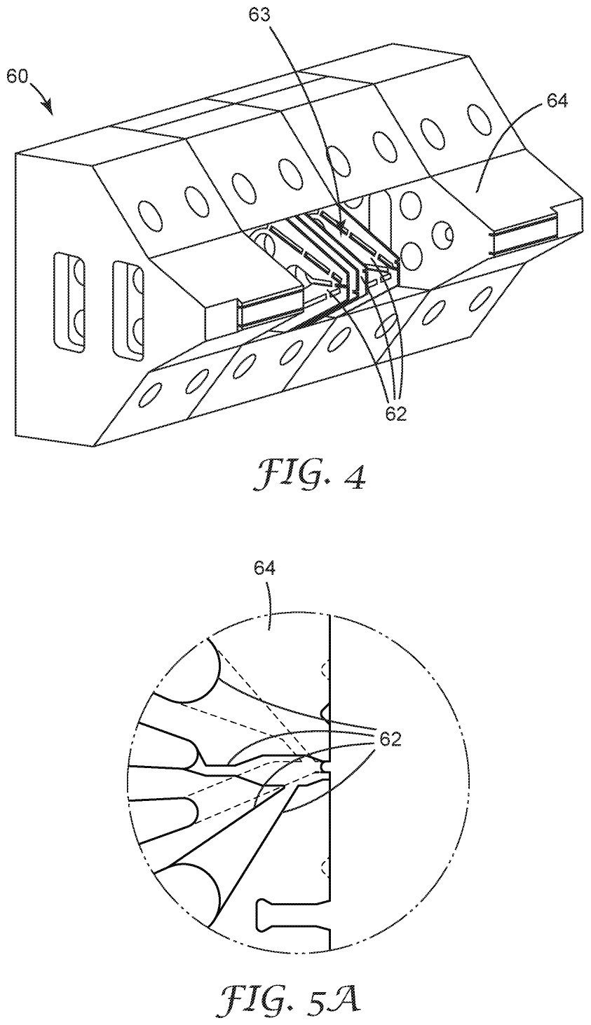

Coextruded ribbon 10 may be at least partially wrapped around roller 52. In some embodiments, a width of roller 52 is greater than a width of coextruded ribbon 10. In this configuration, coextruded ribbon 10 may be wrapped around roller 52 in a helix pattern. Roller may have a substantially cylindrical shaped. For example, roller 52 may have an arcuate profile extending in and out of the page with respect to FIG. 5.

Second layer 14 of coextruded ribbon 10 is in contact with workpiece 54. Workpiece 54 includes backing 56 and workpiece adhesive layer 58. Workpiece 54 may be configured as a continuous web having a length of at least 1 (or in some embodiments, at least 2, 10, 100, 200, 500, 800, or even at least 1000) meters. Workpiece 54 may also be configured as a sheet. Alternatively, workpiece 54 may be configured as a relatively short discontinuous piece.

Backing 56 may include any suitable material. For example, backing 56 may include plastic, paper, metal, a composite film, foil, a polymeric material (e.g., polyvinyl chloride, polyethylene terephthalate, or polycarbonate), felt, or a non-woven scrim. Additional examples of workpieces within the scope of this disclosure include relatively inflexible or rigid articles such as adhesive-coated tiles or laminate flooring planks. Backing 56 may be substantially planar, curved in a single axis or dimension (e.g., the rim of a circular workpiece), or more complex with curvature in at least two axes or dimensions (e.g., a workpiece whose first surface is made up with portions having a variety of orientations).

The adhesive of adhesive layer 58 may be applied to backing 56 by hand or automatically dispensed on the backing as backing 56 is feed into assembly 50. The adhesive may be disposed in a range of from 50% to 100% (in some embodiments, in a range from 55% to 95%, 60% to 90%, 65% to 85%, or even 70% to 80%) of a total surface area of backing 56. The adhesive may be a pressure-sensitive adhesive. Exemplary pressure-sensitive adhesives include a natural rubber-based adhesive, a synthetic rubber-based adhesive, a styrene block copolymer-based adhesive, a polyvinyl ether-based adhesive, a poly(methyl acrylate)-based adhesive, a polyolefin-based adhesive, and a silicone-based adhesive.

In operation, according to some embodiments, workpiece 54 is provided from an intermediate storage state (e.g., from an inventory of raw materials and/or intermediate materials). In other embodiments, workpiece 54 may be provided to the directly from precursor processing (e.g., such as the takeoff feed from a film-forming process). Workpiece 54 may be single layer or multilayer, in some embodiments, the roller 52 is used to convey the workpiece 54 through manufacturing operations in at least one additional layers and/or at least one treatments are applied to a workpiece.

In order to transport workpiece 54 through a manufacturing apparatus, workpiece 54 is conveyed by roller 52 and makes engaging contact with second layer 14. By engaging contact with second layer 14 it is meant that workpiece 54 and specifically adhesive layer 58 contacts second layer 14 of coextruded ribbon 10. Optionally, adhesive layer 58 may contact second layer 14, with sufficient pressure such that the workpiece 54 is at least partially compressed or that the surface of the adhesive conforms somewhat about second layer 14. Compression may be aided with a device such as an engagement cover (not shown), which contacts a side of backing 56 opposite the side that adhesive layer 16.

As shown in FIG. 3, adhesive layer 58 contacts second side 20. By virtue of the presence of protrusions 22, the surface area to which adhesive layer 16 makes contact is minimized relative to a corresponding surface that is free of any protrusions (i.e., has no protrusions). Moreover, the height to pitch ratio or protrusions 22 may be configured to minimize the ability of adhesive layer 58 to penetrate into any of cavities 26. This may help to further minimize the degree of penetration by adhesive layer 58 into cavities 26, thus further minimizing the surface area to which adhesive layer 58 contacts.

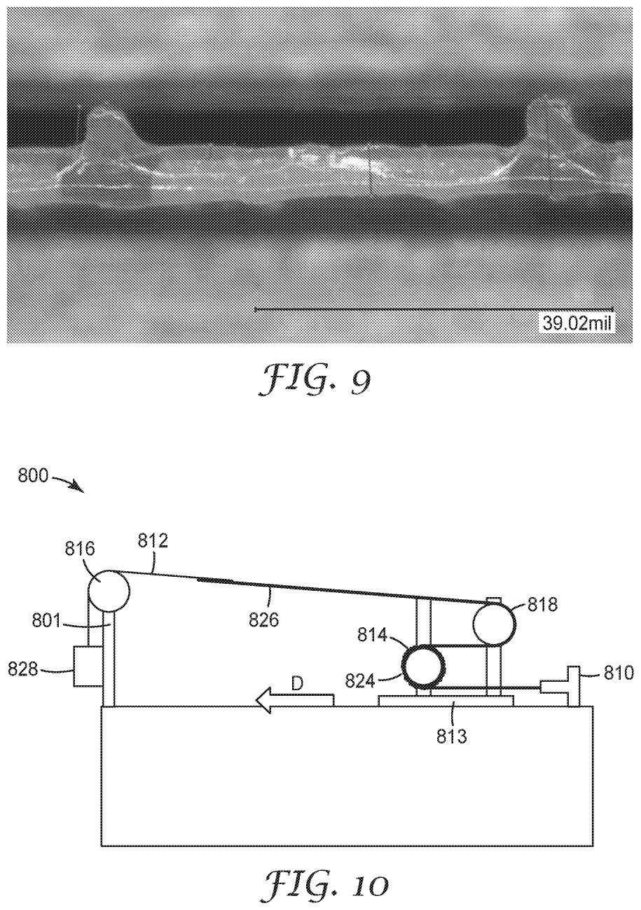

To the extent that adhesive layer 58 contacts second layer 14, the contact is with the repellant material. The repellant material is chosen from a material that will allow for a minimal adhesion between itself adhesive layer 58. The level of adhesion is such that adhesive layer 58 may remain attached to second layer 14 but may be separated therefrom with only a minimal peel force. Methods for measuring peel force are described further herein in the Examples section and with respect to FIG. 10.

The minimal amount of peel force needed to remove adhesive layer 58 from second layer 14 is a result of the synergistic effect provided by coupling the repellent material and the protrusions that minimize the surface area to which adhesive layer 58 contacts. Minimizing the peel force may be helpful because requiring less force to remove adhesive layer may result in less damage to the adhesive. For example, if more release force is required then the likelihood of adhesive being left on a ribbon or the roller itself increases. This may result in damaging the structure of the adhesive layer. In some cases, damaging the structure of the adhesive layer may decrease its adhesive properties. Additionally, in examples where the adhesive requires certain optical performance (e.g., transparency in the case of an optically clear adhesive) deformations caused by removed adhesive may result in reduced transparency, altered refraction, or cause additional optical defects. Moreover, with respect to a roller or other intermediate placed between workpiece 54 and roller 52, the left-over adhesive on the roller may need to be removed, which may cause unnecessary stoppages in production and cost time and labor.

Although assembly 50 is described as including an idle roller it is understood that coextruded ribbon 10 may be used on other types of transport rolls. For example, coextruded ribbon 10 may be used on drive rolls.

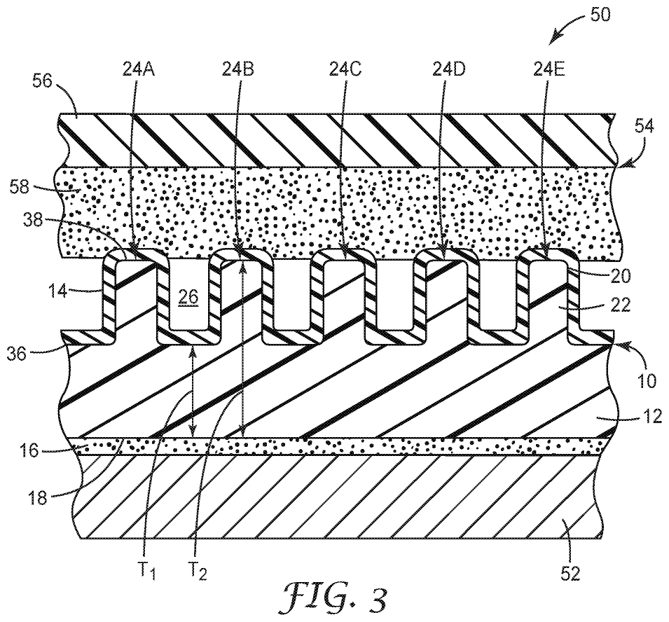

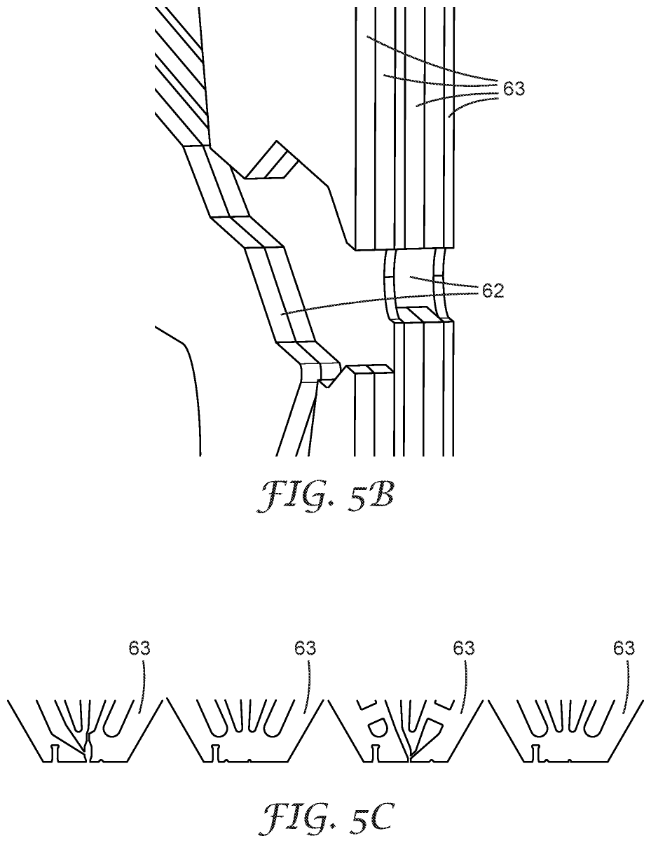

Coextruded ribbon 10 may be formed by providing or receiving a first feedstock of the polymeric material forming first layer 12 as well as a second feedstock of the repellant material of second layer 14. Each feedstock is separately feed into an extruder and extruded therefrom. The extruder may include a die that is configured to form protrusions 22. FIG. 4 is a perspective view of die 60, which includes orifices 62 defined by shim 63 and disposed about tip 64. FIG. 5A is a schematic view showing a pattern of orifices 62 about tip 64. FIG. 5B is a perspective view showing shims 63 and orifices 62 and stacked together and FIG. 5C is an exploded view of orifices 62 of FIG. 5B. FIGS. 6-8 show different patterns of shims 63. FIG. 6A shows a first pattern of orifices 62. FIG. 6B is a zoomed view of tip 64.

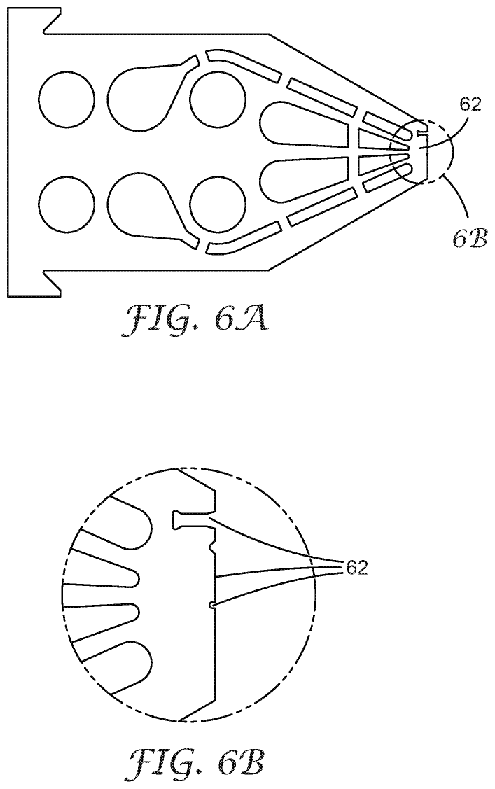

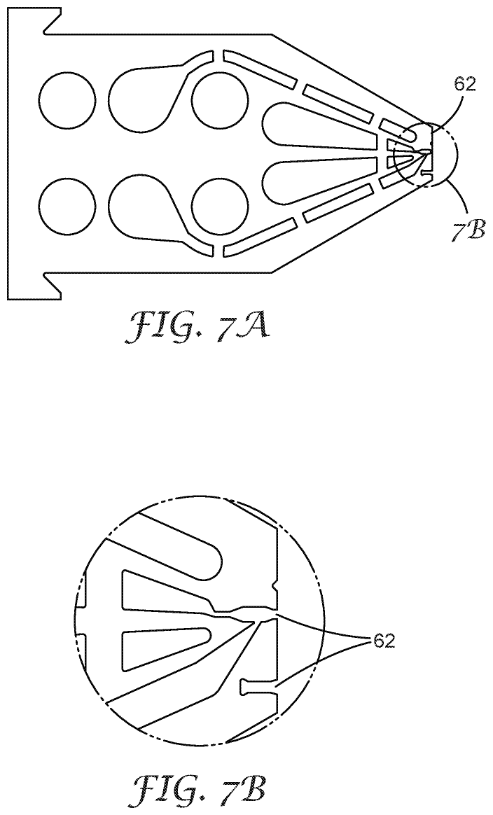

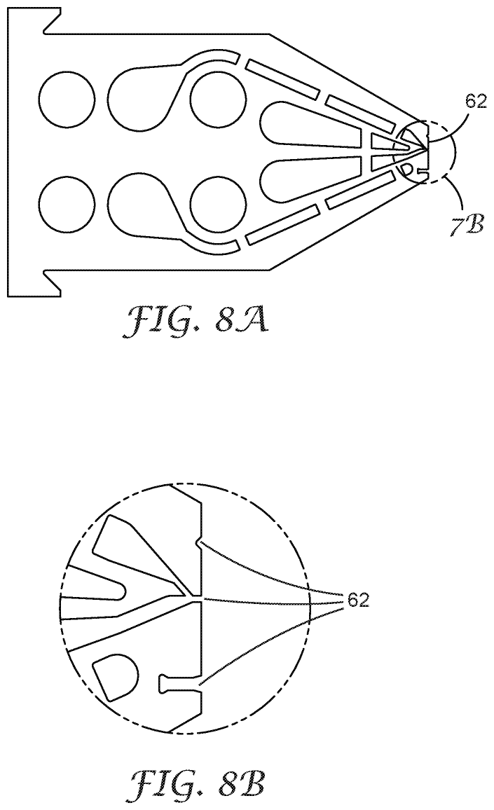

FIG. 7A shows a second pattern of orifices 62. FIG. 7B is a zoomed view of tip 64. FIG. 8A shows a first pattern of orifices. FIG. 8B is a zoomed view of tip 64. FIG. 9 is a photograph showing coextruded ribbon 10 coming off die 60. Die 60 can be formed from any suitable material. Exemplary materials for the die include a plastic, a ceramic, a metal, or a combination thereof.

Alternatively, the feedstocks may be coextruded and a plate having a plurality of ridges may be pressed against the extruded product to form protrusions 22. Adhesive layer 16 may be separately coated on first layer 12 or a third feedstock of the adhesive material may be coextruded with the first and second feedstocks.

### EXEMPLARY EMBODIMENT

The following exemplary embodiments are provided, the numbering of which is not to be construed as designating levels of importance:
1A. A coextruded ribbon comprising first and second layers:

the first layer comprising a polymeric material and further comprising:
a first side optionally having an adhesive thereon; and
an opposed second side having a plurality of protrusions extending therefrom,
and the second layer comprising a repellant material contacting the plurality of protrusions.
2A. The coextruded ribbon of Exemplary Embodiment 1A, wherein the first side is planar.
3A. The coextruded ribbon of Exemplary Embodiment 1A, wherein the first side is nonplanar.
4A. The coextruded ribbon of any preceding A Exemplary Embodiment, wherein the first side has a total surface area, and wherein the adhesive is disposed in a range from 50% to 100% (in some embodiments, in a range from 55% to 95%, 60% to 90%, 65% to 85%, or even 70% to 80%) of a total surface area of the first side.
5A. The coextruded ribbon of any preceding A Exemplary Embodiment, wherein the adhesive comprises a pressure-sensitive adhesive.
6A. The coextruded ribbon of any preceding A Exemplary Embodiment, wherein the adhesive comprises at least one of a natural rubber-based adhesive, a synthetic rubber-based adhesive, a styrene block copolymer-based adhesive, a polyvinyl ether-based adhesive, a poly(methyl acrylate)-based adhesive, a polyolefin-based adhesive, or a silicone-based adhesive (where “-based” means contains at least 50% weight, based on the total weight of the adhesive).
7A. The coextruded ribbon of any preceding A Exemplary Embodiment, wherein the polymeric material comprises at least one of a polyester (e.g., polyethylene terephthalate), a polyurethane, a polyethylene, a polypropylene, a mixture thereof, or a copolymer thereof.
8A. The coextruded ribbon of Exemplary Embodiment 7A, wherein the polyethylene has a density in a range from 0.80 g/cm³ to 0.86 g/cm³ (in some embodiments, in a range from 0.81 g/cm³ to 0.85 g/cm³, or even from 0.82 g/cm³ to 0.84 g/cm³).
9A. The coextruded ribbon of Exemplary Embodiment 7A, wherein the polyethylene has a density in a range from 0.90 g/cm³ to 0.92 g/cm³ (in some embodiments, in a range from 0.90 g/cm³ to 0.91 g/cm³).
10A. The coextruded ribbon of Exemplary Embodiment 7A, wherein the polyethylene has a density in a range from 0.92 g/cm³ to 0.96 g/cm³ (in some embodiments, in a range from 0.93 g/cm³ to 0.95 g/cm³).
11A. The coextruded ribbon of any preceding A Exemplary Embodiment, wherein the ribbon has first and second opposed ends, and wherein the protrusions are elongated and are spaced between the first and second ends of the ribbon.
12A. The coextruded ribbon of any preceding A Exemplary Embodiment, wherein the plurality of protrusions is arranged as adjacent rows of protrusions.
13A. The coextruded ribbon of Exemplary Embodiment 12A, wherein a pitch between adjacent protrusions is in a range of from 0.2 mm to 5 mm (in some embodiments, in a range from 0.5 mm to 4.5 mm, 1.0 mm to 4.0 mm, 1.5 mm to 3.5 mm, or even 2.0 mm to 3 mm) (where “pitch” refers to a distance between adjacent protrusions).
14A. The coextruded ribbon of any preceding A Exemplary Embodiment, wherein adjacent protrusions define a cavity therebetween.
15A. The coextruded ribbon of Exemplary Embodiment 14A, wherein a height of the plurality of protrusions is independently defined by a distance between a cavity and a tip of the protrusion.
16A. The coextruded ribbon of Exemplary Embodiment 15A, wherein the height of the plurality of protrusions is independently in a range of from 0.1 mm to 5.0 mm (in some embodiments, in a range from 0.5 mm to 4.5 mm, 1.0 mm to 4.0 mm, 1.5 mm to 3.5 mm, or even 2.0 mm to 3.0 mm).
17A. The coextruded ribbon of either Exemplary Embodiment 15A or 16A, wherein a height to pitch ratio is in a range of from 1:1 to 1:10 (in some embodiments, in a range from 1:2 to 1:9, 1:3 to 1:8, 1:4 to 1:7, or even 1:5 to 1:6).
18A. The coextruded ribbon of any preceding A Exemplary Embodiment, wherein a cross-sectional shape of the protrusions is independently a triangle, a square, a rectangle, a diamond, a hexagon, a trapezoid, or a semi-circle.
19A. The coextruded ribbon of any of Exemplary Embodiments 15A to 18A, wherein the protrusions each have a tip, and wherein each tip independently comprises in a range from 0.5% to 5.0% (in some embodiments, in a range from 1% to 4.5%, 1.5% to 4.0%, or even 2.0% to 3.5%) of the height of the respective protrusion.
20A. The coextruded ribbon of any of Exemplary Embodiments 15A to 18A, wherein the protrusions each have a tip, and wherein the tips of the protrusions are in a range from 1.0% to 15.0% (in some embodiments, in a range from 1.5% to 14.5%, 2.0% to 14.0%, 2.5% to 13.5%, 3.0% to 13.0%, 3.5% to 12.5%, 4.0% to 12.0%, 4.5% to 11.5%, 5.0% to 11.0%, 5.5% to 10.5%, 6.0% to 10.0%, 6.5% to 9.5%, 7.0% to 9.0%, or even 7.5% to 8.5%) of the surface area of the second side.
21A. The coextruded ribbon of any preceding A Exemplary Embodiment, wherein the repellant material comprises at least one of:
   a siloxane material; or
   a mixture of a thermoplastic polymer and a fluoropolymer additive.
22A. The coextruded ribbon of Exemplary Embodiment 21A, wherein the siloxane material comprises polydimethylsiloxane.
23A. The coextruded ribbon of either Exemplary Embodiment 21A or 22A, wherein the siloxane material comprises a siloxane backbone and a hydrocarbon side chain having a number average of at least 8 (in some embodiments, at least 10, 15, 20, 25, 30, 35, 40, or even at least 45) carbon atoms.
24A. The coextruded ribbon of any of Exemplary Embodiments 21A to 23A, wherein the siloxane material comprising polydimethylsiloxane is free of vinyl groups (i.e., contains less than 2 (in some embodiments, less than 1.5, 1, 0.5, 0.25, or even zero) percent by weight) or free of crosslinkable groups (i.e., contains less than 2 (in some embodiments, less than 1.5, 1, 0.5, 0.25, or even zero) percent by weight).
25A. The coextruded ribbon of any of Exemplary Embodiments 21A to 24A, wherein the repellent material further comprises:

a thermally processable polymer; and

a siloxane material melt additive.
26A. The coextruded ribbon of any of Exemplary Embodiments 21A to 25A, wherein the siloxane material has a viscosity at 25° C. in a range from 5,000,000 to 10,000,000 (in some embodiments, in a range from 6,500,000 to 9,500,000, 7,000,000 to 9,000,000, or even 7,500,000 to 8,500,000) centistokes at ambient temperature (i.e., about 25° C.) using a viscometer (obtained under the trade designation “GÖTTFERT RHEOGRAPH 2003 CAPILLARY RHEOMETER” from GÖTTFERT Werkstoff-Prüffmaschinen GmbH, Buchen, Germany) and used according to the protocol of ASTM D3835 (2008), the disclosure of which is incorporated herein by reference.
27A. The coextruded ribbon of any of Exemplary Embodiments 21A to 26A, wherein the siloxane material is a copolymer that is greater than 50 (in some embodiments, greater than 45, 40, 35, 30, 25, 20, 15, 10, or even greater than 5) wt. % polydimethylsiloxane.
28A. The coextruded ribbon of any of Exemplary Embodiments 21A to 27A, wherein the siloxane material is copolymer at least one of (a) a polyorganosiloxane and a polyolefin or (b) a polyorganosiloxane and a polycarbonate.
29A. The coextruded ribbon of any of Exemplary Embodiments 21A to 28A, wherein the fluoropolymer additive comprises a composition according to the formula:

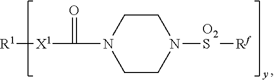

wherein

R¹ is a linear or branched C₂-C₄₀ hydrocarbyl group;

R^{f} is a perfluorinated group comprising a number-average of 3 to 5 carbons;

X¹ is selected from the group consisting of —NH— and a bond, and

y is 1 to 3.
30A. The coextruded ribbon of Exemplary Embodiment 29A, wherein R^{f} has a number average of 3 carbons.
31A. The coextruded ribbon of any of Exemplary Embodiments 21A to 30A, wherein the thermoplastic polymer is at least one of a polyamide, a polyester, a polyurethane, an epoxide, an epoxy resin, a (meth)acrylate, a polystyrene, a silicone, a polyolefin, or a mixture thereof.
32A. The coextruded ribbon of any of Exemplary Embodiments 29A to 31A, wherein R¹ is a (C₂-C₄₀)alkyl or (C₂-C₄₀)alkylene (in some embodiments, (C₂-C₁₈)alkyl or (C₂-C₁₈)alkylene).
33A. The coextruded ribbon of any of Exemplary Embodiments 29A to 32A, wherein R¹ is (C₄-C₁₂)aryl or (C₄-C₁₂)arylene (in some embodiments, (C₆-C₈)aryl or (C₆-C₈)arylene).
34A. The coextruded ribbon of any preceding A Exemplary Embodiment, wherein the second layer contacts a portion of the plurality of protrusions, the portion is in a range from 50% to 100% (in some embodiments, in a range from 55% to 100%, 60% to 100%, 65% to 100%, 70% to 100%, 75% to 100%, 80% to 100%, 85% to 100%, 90% to 100%, or even 95% to 100%) of the portion of protrusions.
1B. An assembly for forming adhesive articles, the assembly comprising:

the coextruded ribbon of any preceding A Exemplary Embodiment; and

a roller contacting the first side of the first layer.
2B. The assembly of Exemplary Embodiment 1B, wherein the coextruded ribbon has a width, and wherein the roller has a width that is greater than the width of the coextruded ribbon.
3B. The assembly of either Exemplary Embodiment 1B or 2B, wherein the coextruded ribbon is wrapped around the roller.
4B. The assembly of any preceding B Exemplary Embodiment, wherein the coextruded ribbon is wrapped around the roller in a helix pattern.
5B. The assembly of any preceding B Exemplary Embodiment, further comprising a workpiece contacting the plurality of protrusions.
6B. The assembly of Exemplary Embodiment 5B, wherein the workpiece comprises:

a backing; and

an adhesive disposed on the backing.
7B. The assembly of Exemplary Embodiment 6B, wherein the backing comprises at least one of a paper, a polyvinyl chloride, a polyethylene terephthalate, a polycarbonate, a felt, or a non-woven scrim.
8B. The assembly of either Exemplary Embodiment 6B or 7B, wherein the adhesive is disposed in a range of from 50% to 100% (in some embodiments, in a range from 55% to 95%, 60% to 90%, 65% to 85%, or even 70% to 80%) of a total surface area of the backing.
9B. The assembly of any of Exemplary Embodiments 6B to 8B, wherein the adhesive comprises a pressure-sensitive adhesive.
10B. The assembly of any of Exemplary Embodiments 6B to 9B, wherein the adhesive comprises at least one of a natural rubber-based adhesive, a synthetic rubber-based adhesive, a styrene block copolymer-based adhesive, a polyvinyl ether-based adhesive, a poly(methyl acrylate)-based adhesive, a polyolefin-based adhesive, or a silicone-based adhesive (where “-based” means contains at least 50% weight, based on the total weight of the adhesive).
11B. The assembly of any of Exemplary Embodiments 6B to 10B, wherein the adhesive contacts at least a portion of the plurality of protrusions.
12B. The assembly of any of Exemplary Embodiments 6B to 11B, wherein the adhesive is free of contact with at least a portion of the cavities (i.e., 5 (in some embodiments, less than 4, 3, 2, 1.5, 1, 0.5, 0.25, or even zero) percent of the total number of cavities).
13B. The assembly of any of Exemplary Embodiments 5B to 12B, wherein a release force of the workpiece from the plurality of portions is greater than a release force of a corresponding workpiece in contact with a corresponding roller that is free of (i.e., does not include) at least one of the plurality of protrusions or the repellant material.
1C. A method of making the coextruded ribbon of any preceding A Exemplary Embodiment or B Exemplary Embodiment, the method comprising:

coextruding a mixture of the polymeric material and the repellant material through a die that has a profile that forms the plurality of protrusions.

### EXAMPLES

Various embodiments of the present disclosure can be better understood by reference to the following Examples which are offered by way of illustration. The present disclosure is not limited to the Examples given herein.

### Example 1

A coextrusion die as generally depicted in FIG. 4. and assembled with a multi-shim repeating pattern of extrusion orifices as generally illustrated in FIGS. 5A to 5C, was prepared. Shims are assigned four-digit numbers for ease of reference. The thickness of the shims in the repeat sequence was 2 mils (0.51 mm) for shim 7579, and 4 mils (1.02 mm) for shims 7865 and 8162. These three shim designs are shown in FIGS. 6 to 8, respectively. These shims were formed from stainless steel, with perforations cut by a wire electron discharge machining The shims were stacked in a repeating sequence of 8162, 8162, 7579, 7865, 7865, 7579, 7865, 7865, 7579, 7865, 7865, 7579, 7865, 7865, and 7579. The extrusion orifices were aligned in a collinear, alternating arrangement. The total width of the shim setup was about 15 cm (6 inches).

The inlet fittings on the two end blocks were connected to conventional single-screw extruders. The extruder feeding the first cavity, the rib base, was loaded with a dry blend of polymer pellets containing 98 weight percent ethylene acrylate copolymer (obtained under the trade designation “ELVALOY 12024S” from Dow DuPont Inc., Wilmington, Del.) plus 2 weight percent red color concentrate. The extruder feeding the second cavity, the film base, was loaded with a dry blend of polymer pellets containing 98 weight percent ethylene acrylate copolymer (“ELVALOY 12024S”) plus 2 weight percent blue color concentrate. The extruder feeding the third cavity, the rib tip, and the fourth cavity, the film top, was loaded with a dry blend of polymer pellets containing 80 weight percent olefin block copolymer (obtained under the trade designation “INFUSE 9530” from Dow DuPont Inc.), plus 20 weight percent of an olefin modified silicone, which is described in U.S. Pat. No. 9,187,678 (Boardman et al.), and had a silicone concentration of 15 wt. %. It is a mixture that is 15 parts by weight alkyl dimethicone and 85 parts by weight of a 0.923 g/cc polyethylene having Melt Index (MI) of 5.6 (obtained under the trade designation “NA217000” from LyondellBasell, Houston, Tex.). This olefin-modified silicone is referred to, throughout this specification, for brevity, as “15% OMS”. The melt was extruded vertically into an extrusion quench takeaway. The extrusion temperature was 204° C. The extrudate was quenched onto a chill roll with the ribbed side in contact with the chill roll, and collected in roll form.

Additional extrusion conditions:
Extrusion Rate of rib base: 0.6 kg/hr.
Extrusion Rate of film base: 1.4 kg/hr.
Extrusion Rate of rib tip: 0.5 kg/hr.
Extrusion Rate of film top: 0.5 kg/hr.
Takeaway Speed: 1.5 m/min.

A cross-sectional photograph of the extrudate is shown in FIG. 9.

Using a conventional, optical microscope, the following cross-web dimensions were measured:
Base Thickness: 0.15 mm
Total Height: 0.29 mm

Rib Width: 0.11 mm
Base Release thickness: 0.04 mm
Rib Release thickness: 0.12 mm
Rib to Rib spacing: 1.22 mm

### Transport Force Test Apparatus and Method:

Evaluations of engagement covers made from coextruded ribbons were carried out using a peel tester (obtained under the trade designation “TL-2300 INTERMEDIATE SPEED RANGE SLIP/PEEL TESTER” from IMASS, Inc., Accord, Mass.) with a conveying apparatus attached thereto to create an interaction between an adhesive-coated workpiece (i.e., adhesive tape) and transport rollers.

As shown in FIG. 10, apparatus 800 included a load cell 810 to which a 5 cm (2 inch) wide adhesive tape 826 (obtained under the trade designation “3M POLYESTER FILM TAPE 850” from 3M, St. Paul, Minn.) was attached with the adhesive side facing upwards. The adhesive tape had a polyester film backing of 0.02 mm thickness and an acrylic adhesive of 0.03 mm thickness, for a total tape thickness of 0.05 mm. The tape had an adhesion to steel of 334.84 gm/cm width. The apparatus also included drive screw-(not shown)-driven platen 813 on which idler transport roll 814 and idler roll 818 were mounted. Transport roll 814 was wrapped with the engagement cover 824 to be tested. Engagement cover 824 was applied in the form of a ribbon, which was wrapped around transport roll 814, so that the ribs on the ribbon ran along the machine direction of the test apparatus (or, in other words, perpendicular to the roll's axis). In Example 8 only, engagement cover 824 was applied in the form of a ribbon, and was applied so that the ribs on the ribbon ran along the direction of the axis of the roller (that is, perpendicular to the direction of the ribs in all other tests). In both instances, if multiple pieces of ribbon were needed to cover the entire roll, care was taken to ensure that the pieces were precisely applied and the roll was completely covered without any gaps and without any instances of pieces overlapping. Idler roll 816 was mounted to the tester body via support mount 801 and did not move with platen 813 and the other rolls. Flexible polyester film strip 812 was draped over idler roll 816. Adhesive tape 826 was wrapped around transport roll 814 having engagement cover 824, with the tape's adhesive side engaging the engagement cover. Adhesive tape 826 was further wrapped around idler roll 818, with the non-adhesive side engaging this roll. Adhesive tape 826 was then attached to strip 812 from the underside that is, with the adhesive side of tape 826 facing upwards. Rolls 814 and 818 were each 10 cm (4 inch) diameter aluminum rolls and roll 816 was a 15 cm (6 inch) diameter aluminum roll. The apparatus was configured such that adhesive tape 826 passed through about a 180° wrap of transport roll 814 having engagement cover 824. Weight 828, having a mass of 0.9 kg (2 pound), was attached to the free end of strip 812 to impart line tension in strip 812 and adhesive tape 826, so as to ensure positive and consistent engaging contact of adhesive tape 826 with engagement cover 824. Upon activation, platen 813 was driven in direction D to pull a length of strip 812 and adhesive tape 826 and convey a length of adhesive tape 826 over rolls 814 and 818.

For each engagement cover to be evaluated, three replicate tests were run, each at a rate of 30 cm (12 inches) per minute for a test period of 60 seconds. The force at the load cell was recorded. The data for the first 10 seconds was ignored because it includes inconsistent artifacts from the start-up of the platen motion. The force recorded over the following 50 seconds was averaged over that time, and the root-mean-squared (RMS) statistic, a measure of variability, was calculated. Results for the three replicate tests were averaged. The measured transport force, which differs from the 0.9 kg (900 gm) original static tension, represents interaction between an engagement cover and the adhesive on the tape.

### Example 2

Example 2 was prepared as described for Example 1, but at a different time. Natural variation resulted in slightly different measurements.

Using a conventional, optical microscope, the following cross-web dimensions were measured:
Base Thickness: 0.14 mm
Total Height: 0.24 mm
Rib Width: 0.13 mm
Rib to Rib spacing: 1.14 mm

### Example 3

Example 3 was prepared as described for Example 1, except that in place of the 20 weight percent of an olefin-modified silicone referred to as “15% OMS”, 20 weight percent of a polydimethylsiloxane polyoxamide elastomer, which may be prepared generally as described in Example 16 of U.S. Pat. No. 7,501,184 (Leir et al.), with an ester equivalent weight of 20,010 grams/equivalent (determined by titration, as generally described at column 41, line 50 through column 42, line 3, in U.S. Pat. No. 8,063,166 (Sherman et al.)), and formed into free-flowing pellets, was used instead. This polydimethylsiloxane polyoxamide elastomer is referred to, throughout this specification, for brevity, as “Elastomer 1”.

Using a conventional, optical microscope, the following cross-web dimensions were measured:
Base Thickness: 0.14 mm
Total Height: 0.24 mm
Rib Width: 0.13 mm
Base Release thickness: 0.04 mm
Rib Release thickness: 0.12 mm
Rib to Rib spacing: 1.14 mm

### Example 4

Example 4 was prepared as described for Example 1, except that when the extrudate was quenched onto a chill roll and collected in roll form, the chill roll had upon it a ribbed sleeve with ribs at 45 degrees to the extrusion direction, so as to form depressions in the film's ribs, with the rows defined by the depressions lying at an angle of 45 degrees to the film ribs themselves. A nip roll was also used to ensure the formation of the depressions. There were 10 grooves per inch, (2.54 cm). The groove depth was 0.25 mm (10 mils). The groove width was 1 mm.

Using a conventional, optical microscope, the following cross-web dimensions were measured:
Base Thickness: 0.14 mm
Total Height: 0.24 mm
Rib Width: 0.13 mm
Rib to Rib spacing: 1.14 mm

### Example 56

Example 5 was prepared as described for Example 1, except the extruder feeding the third cavity, the rib tip, and the fourth cavity, the film top, was loaded with a dry blend of polymer pellets containing 80 weight percent polyethylene homopolymer (obtained under the trade designation “PETROTHENE NA217000” from Equistar Chemicals LP, Houston, Tex.) rather than 80 weight percent of the olefin block copolymer (“INFUSE 9530”). Also, the chill roll had upon it the same ribbed sleeve as that used in Example 4.

Using a conventional, optical microscope, the following cross-web dimensions were measured:
Base Thickness: 0.14 mm
Total Height: 0.24 mm
Rib Width: 0.13 mm
Rib to Rib spacing: 1.14 mm

### Example 6

Example 6 was prepared as described for Example 1, except that in place of the extruder feeding the third cavity, the rib tip, and the fourth cavity, the film top, being loaded with a dry blend of polymer pellets containing 80 weight percent olefin block copolymer (“INFUSE 9530”) plus 20 weight percent of the olefin-modified silicone “15% OMS”, a dry blend of polymer pellets containing 99 weight percent olefin block copolymer (“INFUSE 9530”) plus 1 weight percent of a fluorinated C-18 diester synthesized, as described at column 11, lines 47-65, of U.S. Pat. No 7,396,866 (Jariwala et al.), was used. The additive material used here at 1 weight percent is referred to, throughout this specification, for brevity, as “C-18 diester.”

Using a conventional, optical microscope, the following cross-web dimensions were measured:
Base Thickness: 0.14 mm
Total Height: 0.24 mm
Rib Width: 0.13 mm
Rib to Rib spacing: 1.14 mm

### Example 7

Example 7 was prepared as described for Example 6, except that 99 weight percent of the polyethylene homopolymer (“PETROTHENE NA217000”) was used in place of the 99 weight percent olefin block copolymer (“INFUSE 9530”).

Using a conventional, optical microscope, the following cross-web dimensions were measured:
Base Thickness: 0.14 mm
Total Height: 0.24 mm
Rib Width: 0.13 mm
Rib to Rib spacing: 1.14 mm

### Example 8

Example 8 was prepared as described for Example 4. When performing the Transport Force Test, though, the film was applied to the roller at the perpendicular angle, as outlined in the description of the Test Method.

### Example 9

Example 9 was prepared as described for Example 1, except that the extruder feeding the third cavity, the rib tip, and the fourth cavity, the film top, was loaded with dry polymer pellets containing 100 weight percent olefin block copolymer (“INFUSE 9530”) rather than a dry blend of 80 weight percent olefin block copolymer (“INFUSE 9530”) plus 20 weight percent of the olefin-modified silicone “15% OMS.”

In addition, the extrusion temperature was 190° C. Some of the extrusion conditions were also changed:
Extrusion Rate of rib base: 0.5 kg/hr.
Extrusion Rate of film base: 1.4 kg/hr.
Extrusion Rate of rib tip: 0.6 kg/hr.
Extrusion Rate of film top: 0.6 kg/hr.
Takeaway Speed: 4.5 m/min.

Using a conventional, optical microscope, the following cross-web dimensions were measured:
Base Thickness: 0.17 mm
Total Height: 0.32 mm
Rib Width: 0.13 mm
Rib to Rib spacing: 1.00 mm

### Example 10

Example 10 was made with the same extrusion die as all previous Examples, except that the shims providing the rib orifice have an opening of 1 mm, instead of 0.635 mm. The shims providing the base section were the same as for all previous Examples, but there was only a single feed used, to provide a single layer base section.

Materials fed to the extruder feeding the third cavity, the rib tip, were identical to those of Example 5. The extrusion temperature was 190° C.
Additional extrusion conditions:
Extrusion Rate of rib base: 1.2 kg/hr.
Extrusion Rate of film base: 1.6 kg/hr.

Extrusion Rate of rib tip: 0.9 kg/hr.
Takeaway Speed: 2.1 m/min.

Using a conventional, optical microscope, the following cross-web dimensions were measured:
Base Thickness: 0.25 mm
Total Height: 0.75 mm
Rib Width: 0.15 mm

Rib to Rib spacing: 1.00 mm

### Comparative Example C1

For Comparative Example C1, aluminum engagement roll 814 was left bare and not covered with any engagement cover 824, and the Transport Force Test was run.

### Comparative Example C2

For Comparative Example C2, aluminum engagement roll 814 was wrapped with a commonly used roller “wrap tape” (obtained under the trade designation “TESA PRINTER'S FRIEND 4863” from Tesa Tape, Inc., Charlotte, N.C.), and the Transport Force Test was run.

The Composition of the Examples is summarized in Table 1, below.

TABLE 1

| | Composition | | | | Dimensions | | | |
|---|---|---|---|---|---|---|---|---|
| | | | Release | | Rib | Rib | Spacing | Base |
| | Primary | Primary | Concentration | Primary | Height | Width | Between Ribs | Thickness |
| Example | Release Base | Release | % | Base | mm | mm | mm | mm |
| 2 | INFUSE | 15% OMS | 20 | ELVALOY | 0.10 | 0.13 | 1.14 | 0.14 |
| | 9530 | | | 12024S | | | | |
| 3 | INFUSE | Elastomer 1 | 20 | ELVALOY | 0.10 | 0.13 | 1.14 | 0.14 |
| | 9530 | | | 12024S | | | | |
| 4 | INFUSE | 15% OMS | 20 | ELVALOY | 0.10 | 0.13 | 1.14 | 0.14 |
| | 9530 | | | 12024S | | | | |
| 5 | PETROTHENE | 15% OMS | 20 | ELVALOY | 0.10 | 0.13 | 1.14 | 0.14 |
| | NA217000 | | | 12024S | | | | |
| 6 | INFUSE | C-18 diester | 1 | ELVALOY | 0.10 | 0.13 | 1.14 | 0.14 |
| | 9530 | | | 12024S | | | | |
| 7 | PETROTHENE | C-18 diester | 1 | ELVALOY | 0.10 | 0.13 | 1.14 | 0.14 |
| | NA217000 | | | 12024S | | | | |
| 8 | INFUSE | 15% OMS | 20 | ELVALOY | 0.10 | 0.13 | 1.14 | 0.14 |
| | 9530 | | | 12024S | | | | |
| 9 | INFUSE | NA | 0 | ELVALOY | 0.15 | 0.13 | 1.00 | 0.17 |
| | 9530 | | | 12024S | | | | |
| 10 | PETROTHENE | 15% OMS | 20 | ELVALOY | 0.50 | 0.15 | 1.00 | 0.25 |
| | NA217000 | | | 12024S | | | | |
| C1 | NA | NA | NA | NA | NA | NA | NA | NA |
| C2 | NA | NA | NA | NA | NA | NA | NA | NA |

The results of the Transport Force Test on the specimens of the Examples and of the Comparative Examples are reported in Table 2, below

TABLE 2

| | Transport Force, grams_{f} | | | | | | | |
|---|---|---|---|---|---|---|---|---|
| | Test 1 | | Test 2 | | Test 3 | | Average | |
| Example | Force | RMS | Force | RMS | Force | RMS | Force | RMS |
| 2 | 922.7 | 6.4 | 923.0 | 6.4 | 923.2 | 6.1 | 923.0 | 6.3 |
| 3 | 935.9 | 7.7 | 933.2 | 7.1 | 931.7 | 6.8 | 933.6 | 7.2 |
| 4 | 924.3 | 6.0 | 925.0 | 5.7 | 924.3 | 5.7 | 924.5 | 5.8 |
| 5 | 923.4 | 5.6 | 923.4 | 6.0 | 922.8 | 6.0 | 923.2 | 5.9 |
| 6 | 923.9 | 5.3 | 923.8 | 5.6 | 923.5 | 5.3 | 923.7 | 5.4 |
| 7 | 929.9 | 7.4 | 931.1 | 6.1 | 930.2 | 5.9 | 930.4 | 6.5 |
| 8 | 927.0 | 6.1 | 927.7 | 6.6 | 926.7 | 6.4 | 927.1 | 6.4 |
| 9 | 934.3 | 8.0 | 935.0 | 8.3 | 934.6 | 8.3 | 934.6 | 8.2 |
| 10 | 919.9 | 6.8 | 919.8 | 7.5 | 919.6 | 7.4 | 919.8 | 7.2 |
| C1 | 1387.5 | 101.1 | 1413.3 | 76.9 | 1351.4 | 83.1 | 1384.1 | 87.0 |
| C2 | 932.3 | 8.0 | 931.5 | 8.2 | 928.8 | 7.6 | 930.9 | 7.9 |

All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed can be resorted to by those of ordinary skill in the art, and that such modifications and variations are considered to be within the scope of embodiments of the present disclosure.

1. A coextruded ribbon comprising first and second layers:
the first layer comprising a polymeric material and further comprising:
a first side optionally having an adhesive thereon; and
an opposed second side having a plurality of protrusions extending therefrom,
and the second layer comprising a repellant material contacting the plurality of protrusions.

2. The coextruded ribbon of claim 1, wherein the polymeric material comprises at least one of a polyester, a polyurethane, a polyethylene, a polypropylene, a mixture thereof, or a copolymer thereof.

3. The coextruded ribbon of claim 1, wherein ribbon has first and second opposed ends, and wherein the protrusions are elongated and are spaced between the first and second ends of the ribbon.

4. The coextruded ribbon of claim 1, wherein a pitch between adjacent protrusions is in a range of from 0.2 millimeter to 5 millimeters.

5. The coextruded ribbon of claim 1, wherein a height of the plurality of protrusions is independently in a range of from 0.1 millimeter to 5.0 millimeters.

6. The coextruded ribbon of claim 1, wherein a cross-sectional shape of the protrusions is independently a triangle, a square, a rectangle, a diamond, a hexagon, a trapezoid, or a semi-circle.

7. The coextruded ribbon of claim 1, wherein the repellant material comprises at least one of:
a siloxane material; or
a mixture of a thermoplastic polymer and a fluoropolymer additive.

8. The coextruded ribbon of claim 7, wherein the siloxane material comprises polydimethylsiloxane.

9. A method of making a coextruded ribbon, the method comprising:
coextruding a mixture of a polymeric material and a repellant material through a die,
wherein the polymeric material forms a first layer and the repellant material forms a second layer, and
the die forms a plurality of protrusions on the first layer to which the second layer is attached.

10. The method of claim 9, wherein the polymeric material comprises at least one of a polyester, a polyurethane, a polyethylene, a polypropylene, a mixture thereof, or a copolymer thereof.

11. The method of claim 9, wherein the repellant material comprises at least one of:
a siloxane material; or
a mixture of a thermoplastic polymer and a fluoropolymer additive.

12. The method of claim 11, wherein the siloxane material comprises polydimethylsiloxane.

13. The method of claim 11, wherein the siloxane material is a copolymer that is greater than 50 weight percent polydimethylsiloxane.

14. The method of claim 11, wherein the siloxane material is a copolymer of at least one of (a) a polyorganosiloxane and a polyolefin or (b) a polyorganosiloxane and a polycarbonate.

15. The method of claim 11, wherein the fluoropolymer additive comprises a composition according to the formula: 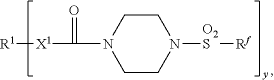
wherein
R¹ is a linear or branched C₂-C₄₀ hydrocarbyl group;
R^{f} is a perfluorinated group comprising a number-average of 3 to 5 carbons;
X¹ is selected from the group consisting of —NH— and a bond, and
y is 1 to 3.
